(19) United States
(12) Patent Application Publication
(10) Pub. No.: US 2017/0341490 A1
(43) Pub. Date: Nov. 30, 2017

(54) DEVICE FOR INSTALLING A WINDSCREEN OF A VEHICLE

(71) Applicant: Sascha Milosavljevic, Reiden (CH)

(72) Inventor: Sascha Milosavljevic, Reiden (CH)

(21) Appl. No.: 15/538,003

(22) PCT Filed: Jul. 8, 2015
(86) PCT No.: PCT/IB2015/055159

§ 371 Date: Jun. 20, 2017

(30) Foreign Application Priority Data
Dec. 22, 2014 (CH) 02003/14

(51) Int. Cl. B60J 1/00; B25J 17/02; B25J 15/06; B62D 65/06; B25J 1/12

(52) U.S. Cl. CPC B60J 1/005; B62D 65/06; B25J 1/12; B25J 15/0616; B25J 17/0275

(57) ABSTRACT

The invention relates to a device for installing a windscreen of a vehicle, which device comprises a support which stands vertically and is adjustable in height, a beam which extends away from the support, and one or more suction cups for holding the windscreen. The one or more suction cups are in each case movably connected by means of a plurality of rods and ball joints to the beam. The rods and ball joints enable a simple movement in all directions relative to the support of a windscreen by a single person, as a ball joint is disposed between a suction cup and a rod, in each case between two rods and between a rod and the beam in each case, and enables a local movement in all directions at each of these articulation points. The movement of the windscreen can take place either manually, pneumatically or hydraulically.

### CROSS-REFERENCE TO RELATED APPLICATIONS

This application is a National Stage application of International Patent Application No. PCT/IB2015/055159, filed on Jul. 8, 2015, which claims priority to Swedish Patent Application No. 0200314, filed on Dec. 22, 2014, each of which is hereby incorporated by reference in its entirety.

### TECHNICAL FIELD

The invention relates to a mobile device for installing a windscreen of a vehicle, such as passenger cars, lorries or buses. More specifically, the invention relates to such a device for installing a screen to replace the screen after sustaining damage, wherein the device is placed onto the floor and installation by a single person is possible.

### BACKGROUND

Such devices are used to enable a person to precisely place, press and bond a windscreen into the screen frame.

### SUMMARY OF THE INVENTION

It is the object of the present invention to provide a device for installing a windscreen of a vehicle, which device can be operated by one person alone. In particular, the device is to rule out damage to the vehicle body, be applicable to all types and dimensions of vehicles and be easy to operate.

A device of the invention for installing a windscreen of a vehicle as disclosed herein comprises a support which stands vertically, a beam which extends away from the support, and one or more suction cups for holding a vehicle windscreen. According to the invention, the one or more suction cups are each movably connected to the beam by means of a plurality of rods and ball joints.

The rods and ball joints enable a simple movement of a windscreen by one person in all directions relative to the support, as a ball joint is disposed between a suction cup and a rod, in each case between two rods and between a rod and the beam in each case, and enables a local movement at each of these points. Thus, it is possible to move and tilt a windscreen in height as well as the lateral, forwards and backwards position relative to the vehicle to change its tilt angles and to also maintain the position reached by adapting the ball joints to be securable. Alternatively, the ball joints may, for safety reasons, each be configured with a clamping or lifting action to brace the ball joints in a selected position. The movement of the ball joints can take place either manually, pneumatically or hydraulically. As such, the person merely needs to guide the windscreen without much effort to position and tilt the windscreen.

Once a windscreen is in the desired position, it is pressed onto the prepared adhesive in the screen frame with the ball joints yielding.

In one embodiment of the invention, the device comprises a suction cup which is movably connected to the beam by at least two rods and at least two ball joints. Then, the suction cup is connected to a first rod, the first rod to the second rod and the second rod to the beam by a ball joint each.

In another embodiment of the invention, the device comprises two suction cups, each movably connected to the beam by at least two rods and two ball joints.

In another embodiment of the invention, the device comprises two suction cups, each movably connected to the beam by at least two rods and ball joints, wherein the rods disposed closest to the beam are connected to a single ball joint which is fastened to the beam. Thus, both suction cups are connected to the beam by the rods and ball joints in a single point.

In another embodiment, handles are disposed on each suction cup.

In another embodiment, the suction cups have pumps to establish a vacuum for suction to a windscreen. Alternatively, the suction cups may each also comprise a clamping system to establish a vacuum.

In another embodiment, an additional mounting bracket is disposed on each of the suction cups, each of which is three-dimensionally rotatable through 360°.

In another embodiment, the beam is connected to the support by a ball joint. In this embodiment, it is possible that a suction cup or a plurality of suction cups is each connected to the beam arm by only one rod and one ball joint at each end of the rod.

In another embodiment, the support is securable to one of the vehicle's wheels by a base element or pedal, wherein the securing means may be actuated manually, electrically or hydraulically.

In another embodiment, the device comprises rollers on which it can be advanced to the vehicle, wherein the rollers are fixable in their position. In a particular embodiment, the rollers are retractable.

In one embodiment of the invention, the ball joints are each rotatable through 360°. This also allows the device to be advanced from both right and left of the vehicle and thus to be used for installing a windscreen.

In another embodiment of the invention, the support is disposed on a rail extending on the floor. This rail can be substantially parallel to the vehicle's longitudinal direction. In another embodiment, such a rail extends substantially in the vehicle's longitudinal direction. Such rails allow the support to be placed in various positions relative to the base element of the support, which is secured to a wheel. Therefore, the device is versatile in application for vehicles of a wide variety of shapes and dimensions.

In another embodiment of the invention, the vertical support is adjustable in height. Such a height adjustment may be implemented by electric motors or a hydraulic system, for example. In addition, it may be actuated manually.

In another embodiment, the device is disassembable or collapsible. This allows the device to be transported even in a small vehicle, such as a delivery van, car or breakdown van, and thus to also be used as a mobile unit.

The invention has the advantage that it consists of relatively few parts when compared to prior art devices and may be easily installed and actuated therewith. The height adjustability of the vertical support and high movability of the ball joints rule out any damage to the vehicle body as the windscreen can be guided into the frame from the front and above with all shapes and types of vehicles without touching the bonnet or roof.

The mechanic merely needs to guide the windscreen during installation to change its position and precisely insert it into the opening. The device can be independently operated by one single person alone. A second person is no longer required. It is easy on the back and shoulders and avoids excessive strain.

The device provides for a quick and efficient installation of a windscreen as several operations such as preparing lute joints and multiple lifting can be done in one step. The device of the invention is mobile as it can be advanced to the vehicle on rollers or wheels and put away again upon completion of the installation. Therein, it is different from devices which are fixed in their position and where the vehicles are advanced to the device on the assembly line.

Further features and advantages of the invention will become apparent from the following description in which the invention is explained in greater detail by means of an exemplary embodiment shown in the schematic drawings.

### BRIEF DESCRIPTION OF THE DRAWINGS

FIG. 1 shows a side view of an exemplary embodiment of the invention.

FIG. 2 shows a front view of an exemplary embodiment of the invention.

FIG. 3 shows a variation of the embodiment of FIG. 2 with an additional stabilising rod.

FIG. 4 shows a variation of the embodiment of FIG. 2 with two series of rods and ball joints connected to the beam at a ball joint.

In the figures, same reference numbers have been used for the same elements and explanations given for a first time apply to all figures, unless expressly noted otherwise.

### DETAILED DESCRIPTION

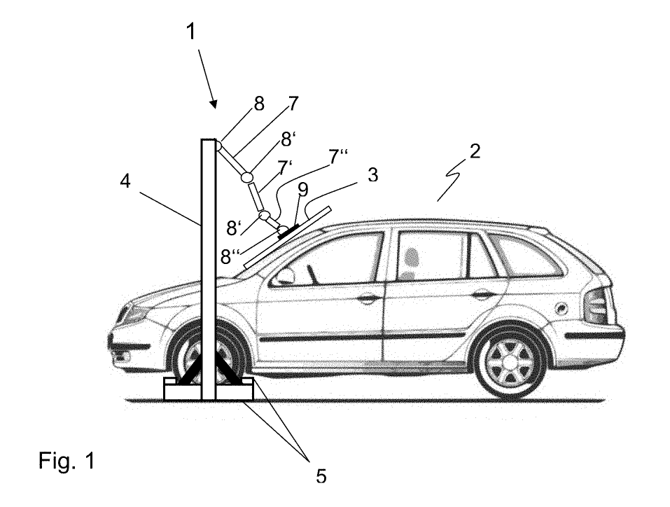

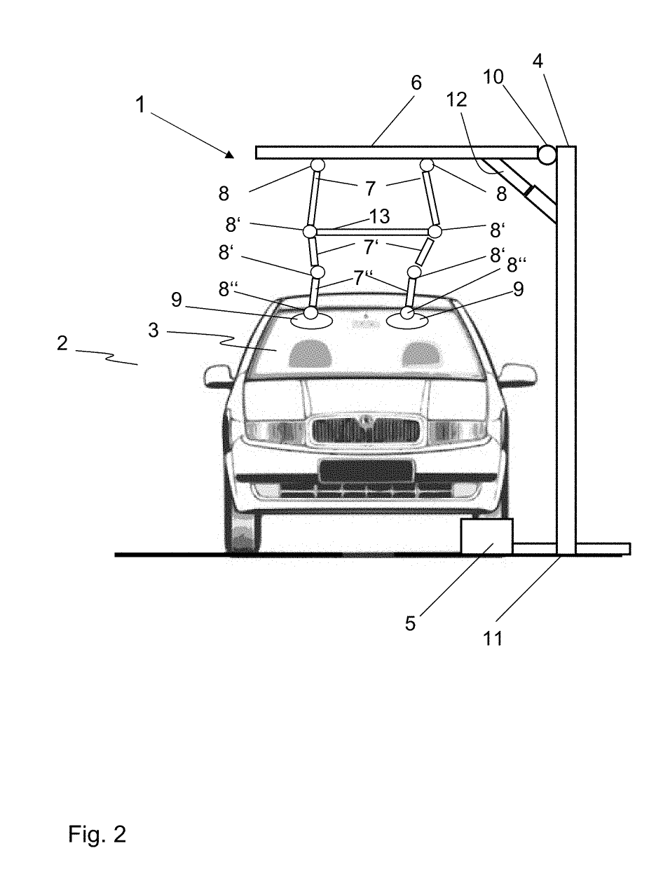

FIGS. 1 and 2 show a device 1 for installing a windscreen 3 of a vehicle 2, which device comprises a vertical support 4 standing on the floor, a base element 5 and a beam 6. Base element 5 comprises two elements to be positioned around the front wheel of vehicle 2 and secured thereto. From the upper end of height-adjustable support 4, a beam 6 (shown in FIG. 2) extends substantially horizontally. A windscreen 3 is held by beam 6 using one or two suction cups 9 and a number of rods 7. The beam, rods 7 and a suction cup 9 are interconnected by ball joints. The exemplary embodiment shown in FIG. 1 comprises a series of three rods 7, four ball joints 8 and a suction cup 9. The first rod 7, which is disposed closest to the beam, is movably connected to beam 6 by a ball joint 8. This rod 7 is, in turn, movably connected with its lower end to a next rod T by a ball joint 8′. This rod T is movably connected by a ball joint 8′ to a last rod 7″ which is movably fastened to suction cup 9 by a last ball joint 8″. Windscreen 3 can be moved, lifted, lowered, traversed and tilted in all directions in a variety of ways and positioned precisely into the opening for the screen and then pressed into place using the plurality of ball joints and rods. As screen 3 can be advanced from above, the risk of damaging the vehicle's bonnet is largely minimised.

The exemplary embodiment of FIG. 2 shows the device with two suction cups 9 and two series of rods 7, 7′ and 7″ and connecting ball joints 8, 8′, 8″. Of these, the first rods 7 are fastened to beam 6 with ball joints 8 and the last rods 7″ are fasted to suction cups 9 with ball joints 8″. In addition, beam 6 is movably connected to support 4 by a ball joint 10. Thus, beam 6 is pivotable in all angular directions relative to support 4. Moreover, beam 6 is supported by a damping support 12.

In one variation, the device for installing a windscreen is adapted to be collapsible by support 12 between beam 6 and vertical support 4 being adapted to be removable, such that beam 6 can be made parallel to support 4 using joint 10. To this end, support 12 extending from vertical support 4 to beam 6 is adapted to be removable, for example, by being connected to beam 6 or support 4 through a hinge. This allows the entire device to be collapsed to stow and/or transport it in a space-saving manner.

Similarly, also for the purpose of space-saving storage and/or transport, in another variation, vertical support 4 is also adapted to be collapsible, for example, by consisting of two or more parts which may be pushed into each other in the manner of a telescope or being collapsible by means of a hinge.

If beam 6 is pivotably connected to a ball joint 10 instead of being connected in a fixed position, the device may also be implemented with a smaller number of rods 7 and ball joints 8, for example with only two rods and three ball joints, wherein a first ball joint connects the beam and the first rod, the second ball joint connects the first and second rods and the third ball joint connects the second rod and a suction cup.

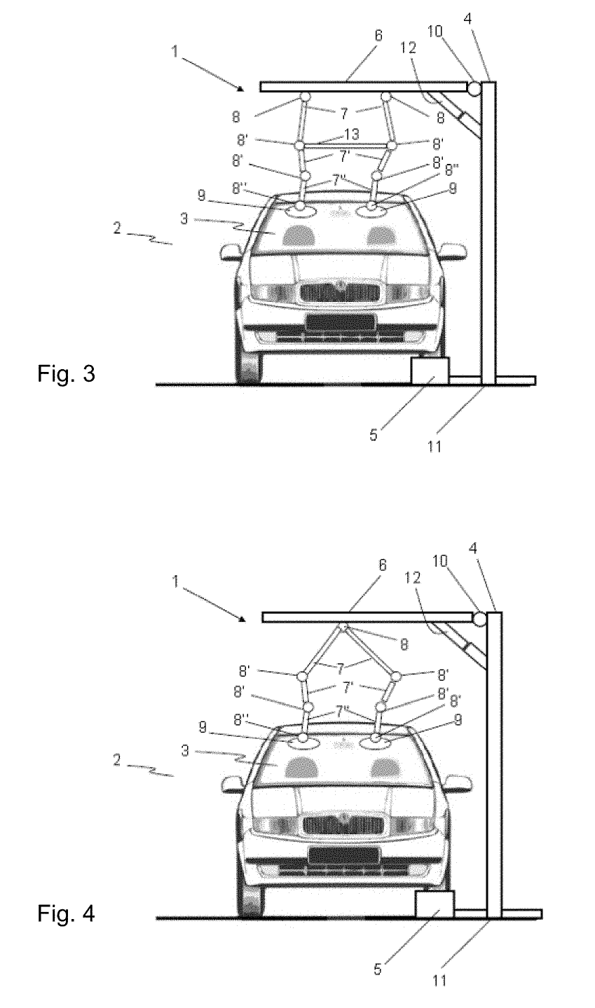

Another variation of the invention is shown in FIG. 3. Device 1 again comprises two series of rods 7 and ball joints 8, 8′, 8″, wherein ball joints 8′ between rods 7 and T of each series are connected by a stabilising intermediate rod 13. One variation of the embodiment is shown in FIG. 4, in which the two series of rods 7, 7′, 7″ are connected to beam 6 in only one point by a ball joint 8.

In another variation of the invention, device 1 comprises, instead of two series of rods 7 and ball joints 8, 8′, 8″ as shown in FIG. 2, only one such series of rods and ball joints and one suction cup.

In another variation of the embodiment according to the figures, beam 6 is adapted to be adjustable in length, for example by a rail system, such that the length of beam 6 can be adjusted to the various widths of vehicle roofs.

Each of these embodiments of the invention may be implemented with one or two or even more suction cups and associated series of rods and ball joints.

The embodiment of FIG. 2 also comprises a rail 11, allowing the support to be moved closer or farer away to or from the vehicle's front wheel. Thus, the device may also be used for vehicles of various body shapes at the wing.

The device comprises rollers or wheels on base element 5, allowing device 1 to be quickly advanced and retracted in a small workshop.

While the present disclosure has been illustrated and described with respect to particular embodiments thereof, it should be appreciated by those of ordinary skill in the art that various modifications to this disclosure may be made without departing from the spirit and scope of the present disclosure.

What is claimed is:

1. A device for installing a windscreen of a vehicle, having a support which stands vertically and a beam which extends away from the support, and one or more suction cups for holding the windscreen,
wherein
the one or more suction cups are each movably connected to the beam by a plurality of rods and ball joints.

2. The device as claimed in claim 1,
wherein
the device comprises a suction cup which is movably connected to the beam by at least two rods and at least two ball joints.

3. The device as claimed in claim 1,
wherein
the device comprises two suction cups which are each movably connected to the beam by a series of at least two rods and two ball joints.

4. The device as claimed in claim 1,
wherein
the beam is pivotably connected to the support by a ball joint.

5. The device as claimed in claim 1,
wherein
the support is securable to the wheel of the vehicle by a base element.

6. The device as claimed in claim 1,
wherein
the support is disposed on a rail extending on the floor.

7. The device as claimed in claim 1,
wherein
the support is adjustable in height.

8. The device as claimed in claim 1,
wherein
the device comprises rollers on which the device is advanceable to a vehicle.

9. The device as claimed in claim 1,
wherein
the device comprises two suction cups, each movably connected to the beam by at least two rods and ball joints, wherein the rods disposed closest to the beam are connected to a single ball joint which is fastened to the beam.

10. The device as claimed in claim 1,
wherein
handles are disposed on each of the suction cups.

11. The device as claimed in claim 1,
wherein
an additional mounting bracket rotatable through 360° is disposed on each of the suction cups.

12. The device as claimed in claim 4,
wherein
the device is collapsible.

13. The device as claimed in claim 3,
wherein
the device comprises a stabilising rod, connecting the ball joints between two rods of both series of rods.

14. The device as claimed in claim 3,
wherein
the two series of rods are connected to the beam in one point by a ball joint.

15. The device as claimed in claim 1,
wherein
the ball joints are adapted to be securable.
